(19) United States
(12) Patent Application Publication
(10) Pub. No.: US 2010/0153207 A1
(43) Pub. Date: Jun. 17, 2010

(54) METHOD AND SYSTEM FOR PROVIDING CONSUMER SERVICES WITH A TELEMATICS SYSTEM

(76) Inventors: Randy Roberts, Lewisville, TX (US); Dane Dickie, Atlanta, GA (US); Michael Peterson, Atlanta, GA (US)

Correspondence Address: HUGHES TELEMATICS, INC., 2002 Summit Blvd, Suite 1800, ATLANTA, GA, 30319, US

(21) Appl. No.: 12/636,559

(22) Filed: Dec. 11, 2009

Related U.S. Application Data
(60) Provisional application No. 61/121,786, filed on Dec. 11, 2008.

(51) Int. Cl. G06Q 30/00; G01C 21/00; G06Q 50/00

(52) U.S. Cl. 705/14.41; 701/300; 705/14.63

(57) ABSTRACT

A telematics unit monitors location information and a vehicle information bus for diagnostic and other vehicle information and a request for services command initiated with hardware coupled to the telematics unit, remotely from another device, or automatically upon the occurrence of a vehicle trigger. The telematics unit composes a request message that includes vehicle location information and an indicator of a type of services requested, and transmits the message to a telematics server. The server performs a table lookup to find entries containing information of requested services available within a predetermined range of the vehicle. The server transmits a response message to the telematics unit, or other device, for presentation of the requested information. The response message may include a file containing promotional information relative to the service provider(s). The TCU may transmit a message that includes metrics relative to how a user played the promotional information file.

### CROSS REFERENCE TO RELATED APPLICATION

The present application claims priority under 35 U.S.C. 119(e) to U.S. Provisional Patent Application No. 61/121,786 filed on Dec. 11, 2008, by Roberts, et al., entitled “Telematics value add chain,” which the present application incorporates herein by reference in its entirety.

### SUMMARY

Provided are methods and systems for vehicle interaction and communication. The methods and system may utilize a telematics control unit (“TCU”) device coupled to a vehicle (this application may also refer to a TCU as a vehicle control unit, or “VCU”).

A user driving, riding in, operating, or otherwise using a vehicle (automobile, boat, plane, heavy truck, heavy equipment, golf cart, train, motorcycle, bicycle, etc.) may desire to know information related to his current, or future location. Alternatively, a user remote from the vehicle may desire to know information relative to the vehicle's location or planned location. The vehicle user, or the remote user, may

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an exemplary vehicle telematics unit;

FIG. 2 is an exemplary network environment;

FIG. 3 is an exemplary operating environment;

FIG. 4 is an exemplary method of operation;

FIG. 5 is an exemplary method of operation;

FIG. 6 is an exemplary method of operation;

FIG. 7 is an exemplary method of operation;

FIG. 8 is an exemplary apparatus; and

FIG. 9 is an exemplary system.

### DETAILED DESCRIPTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

In one aspect, provided is an apparatus comprising a telematics unit. The apparatus can be installed in a vehicle. Such vehicles include, but are not limited to, personal and commercial automobiles, motorcycles, transport vehicles, watercraft, aircraft, and the like. For example, an entire fleet of a vehicle manufacturer's vehicles can be equipped with the apparatus. The apparatus 101 is also referred to herein as the VTU 101. The apparatus can perform any of the methods disclosed herein in part and/or in their entireties.

All components of the telematics unit can be contained within a single box and controlled with a single core processing subsystem or can be comprised of components distributed throughout a vehicle. Each of the components of the apparatus can be separate subsystems of the vehicle, for example, a communications component such as a Satellite Digital Audio Radio Service (SDARS), or other satellite receiver, can be coupled with an entertainment system of the vehicle.

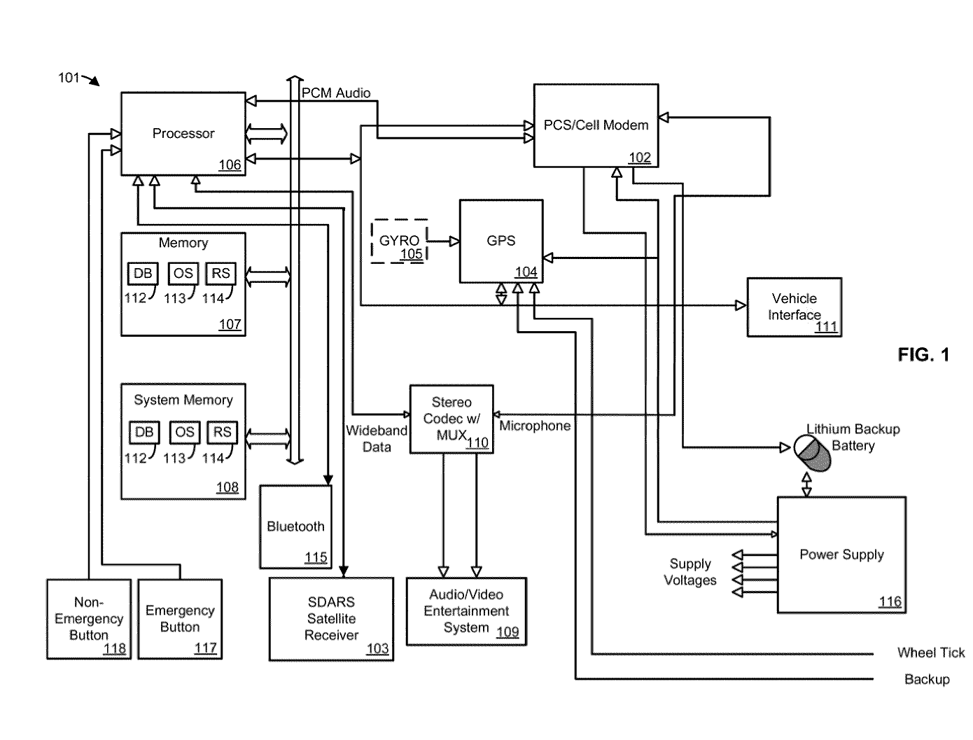

An exemplary apparatus 101 is illustrated in FIG. 1. This exemplary apparatus is only an example of an apparatus and is not intended to suggest any limitation as to the scope of use or functionality of operating architecture. Neither should the apparatus be necessarily interpreted as having any dependency or requirement relating to any one or combination of components illustrated in the exemplary apparatus. The apparatus 101 can comprise one or more communications components. Apparatus 101 illustrates communications components (modules) PCS/Cell Modem 102 and SDARS receiver 103. These components can be referred to as vehicle mounted transceivers when located in a vehicle. PCS/Cell Modem 102 can operate on any frequency available in the country of operation, including, but not limited to, the 850/1900 MHz cellular and PCS frequency allocations. The type of communications can include, but is not limited to GPRS, EDGE, UMTS, 1xRTT or EV-DO. The PCS/Cell Modem 102 can be a Wi-Fi or mobile Worldwide Interoperability for Microwave Access (WIMAX) implementation that can support operation on both licensed and unlicensed wireless frequencies. The apparatus 101 can comprise an SDARS receiver 103 or other satellite receiver. SDARS receiver 103 can utilize high powered satellites operating at, for example, 2.35 GHz to broadcast digital content to automobiles and some terrestrial receivers, generally demodulated for audio content, but can contain digital data streams.

PCS/Cell Modem 102 and SDARS receiver 103 can be used to update an onboard database 112 contained within the apparatus 101. Updating can be requested by the apparatus 101, or updating can occur automatically. For example, database updates can be performed using FM subcarrier, cellular data download, other satellite technologies, Wi-Fi and the like. SDARS data downloads can provide the most flexibility and lowest cost by pulling digital data from an existing receiver that exists for entertainment purposes. An SDARS data stream is not a channelized implementation (like AM or FM radio) but a broadband implementation that provides a single data stream that is separated into useful and applicable components.

GPS receiver 104 can receive position information from a constellation of satellites operated by the U.S. Department of Defense. Alternately, the GPS receiver 104 can be a GLONASS receiver operated by the Russian Federation Ministry of Defense, or any other positioning device capable of providing accurate location information (for example, LORAN, inertial navigation, and the like). GPS receiver 104 can contain additional logic, either software, hardware or both to receive the Wide Area Augmentation System (WAAS) signals, operated by the Federal Aviation Administration, to correct dithering errors and provide the most accurate location possible. Overall accuracy of the positioning equipment subsystem containing WAAS is generally in the two meter range. Optionally, the apparatus 101 can comprise a MEMS gyro 105 for measuring angular rates and wheel tick inputs for determining the exact position based on dead-reckoning techniques. This functionality is useful for determining accurate locations in metropolitan urban canyons, heavily tree-lined streets and tunnels.

One or more processors 106 can control the various components of the apparatus 101. Processor 106 can be coupled to removable/non-removable, volatile/non-volatile computer storage media. By way of example, FIG. 1 illustrates memory 107, coupled to the processor 106, which can provide non-volatile storage of computer code, computer readable instructions, data structures, program modules, and other data for the computer 101. For example and not meant to be limiting, memory 107 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

The processing of the disclosed systems and methods can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

Any number of program modules can be stored on the memory 107, including by way of example, an operating system 113 and software 114. Each of the operating system 113 and software 114 (or some combination thereof) can comprise elements of the programming and the software 114. Data can also be stored on the memory 107 in database 112. Database 112 can be any of one or more databases known in the art. Examples of such databases comprise, DB2®, Microsoft® Access, Microsoft® SQL Server, Oracle®, mySQL, PostgreSQL, and the like. The database 112 can be centralized or distributed across multiple systems. The software 114 can comprise telematics software and the data can comprise telematics data.

By way of example, the operating system 113 can be a Linux (Unix-like) operating system. One feature of Linux is that it includes a set of “C” programming language functions referred to as, “NDBM”. NDBM is an API for maintaining key/content pairs in a database which allows for quick access to relatively static information. NDBM functions use a simple hashing function to allow a programmer to store keys and data in data tables and rapidly retrieve them based upon the assigned key. A major consideration for an NDBM database is that it only stores simple data elements (bytes) and requires unique keys to address each entry in the database. NDBM functions provide a solution that is among the fastest and most scalable for small processors.

It is recognized that such programs and components reside at various times in different storage components of the apparatus 101, and are executed by the processor 106 of the apparatus 101. An implementation of reporting software 114 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

FIG. 1 illustrates system memory 108, coupled to the processor 106, which can comprise computer readable media in the form of volatile memory, such as random access memory (RAM, SDRAM, and the like), and/or non-volatile memory, such as read only memory (ROM). The system memory 108 typically contains data and/or program modules such as operating system 113 and software 114 that are immediately accessible to and/or are presently operated on by the processor 106. The operating system 113 can comprise a specialized task dispatcher, slicing available bandwidth among the necessary tasks at hand, including communications management, position determination and management, entertainment radio management, SDARS data demodulation and assessment, power control, and vehicle communications.

The processor 106 can control additional components within the apparatus 101 to allow for ease of integration into vehicle systems. The processor 106 can control power to the components within the apparatus 101, for example, shutting off GPS receiver 104 and SDARS receiver 103 when the vehicle is inactive, and alternately shutting off the PCS/Cell Modem 102 to conserve the vehicle battery when the vehicle is stationary for long periods of inactivity. The processor 106 can also control an audio/video entertainment subsystem 109 and comprise a stereo codec and multiplexer 110 for providing entertainment audio and video to the vehicle occupants, for providing wireless communications audio (PCS/Cell phone audio), speech recognition from the driver compartment for manipulating the SDARS receiver 103 and PCS/Cell Modem 102 phone dialing, and text to speech and pre-recorded audio for vehicle status annunciation.

Audio/video entertainment subsystem 109 can comprise a radio receiver, FM, AM, Satellite, Digital and the like. Audio/video entertainment subsystem 109 can comprise one or more media players. An example of a media player includes, but is not limited to, audio cassettes, compact discs, DVD's, Blu-ray, HD-DVDs, Mini-Discs, flash memory, portable audio players, hard disks, game systems, and the like. Audio/video entertainment subsystem 109 can comprise a user interface for controlling various functions. The user interface can comprise buttons, dials, and/or switches. In certain embodiments, the user interface can comprise a display screen. The display screen can be a touchscreen. The display screen can be used to provide information about the particular entertainment being delivered to an occupant, including, but not limited to Radio Data System (RDS) information, ID3 tag information, video, and various control functionality (such as next, previous, pause, etc. . . . ), websites, and the like. Audio/video entertainment subsystem 109 can utilize wired or wireless techniques to communicate to various consumer electronics including, but not limited to, cellular phones, laptops, PDAs, portable audio players (such as an iPod), and the like. Audio/video entertainment subsystem 109 can be controlled remotely through, for example, a wireless remote control, voice commands, and the like.

In some aspects, processor 106 can request and obtain data related to the entertainment choices made by vehicle occupants. In one aspect, the processor 106 can accomplish this through one or more vehicle communications buses. The processor 106 can be configured to obtain any available information related to the entertainment choices. Examples of these data include, but are not limited to, website information, channel selection, volume, song information (i.e., artist, title, album, genre, etc. . . . ), television show information (title, actors, genre, etc. . . . ), movie selection (title, actors, genre, etc. . . . ), present radio station setting, station preset information, time stamp and date stamp of radio station selection, global positioning system coordinates, radio status.

Data obtained and/or determined by processor 106 can be displayed to a vehicle occupant and/or transmitted to a remote processing center. This transmission can occur over a wired or a wireless network. For example, the transmission can utilize PCS/Cell Modem 102 to transmit the data. The data can be routed through the Internet where it can be accessed, displayed and manipulated.

The apparatus 101 can interface and monitor various vehicle systems and sensors to determine vehicle conditions. Apparatus 101 can interface with a vehicle through a vehicle interface 111. The vehicle interface 111 can include, but is not limited to, OBD (On Board Diagnostics) port, OBD-II port, CAN (Controller Area Network) port, and the like. The vehicle interface 111, allows the apparatus 101 to receive data indicative of vehicle performance, such as vehicle trouble codes, operating temperatures, operating pressures, speed, fuel air mixtures, oil quality, oil and coolant temperatures, wiper and light usage, mileage, break pad conditions, and any data obtained from any discrete sensor that contributes to the operation of the vehicle engine and drive-train computer. Additionally CAN interfacing can eliminate individual dedicated inputs to determine brake usage, backup status, and it can allow reading of onboard sensors in certain vehicle stability control modules providing gyro outputs, steering wheel position, accelerometer forces and the like for determining driving characteristics. The apparatus 101 can interface directly with a vehicle subsystem or a sensor, such as an accelerometer, gyroscope, airbag deployment computer, and the like. Data obtained, and processed data derived from, from the various vehicle systems and sensors can be transmitted to a central monitoring station via the PCS/Cell Modem 102.

Communication with a vehicle driver can be through an infotainment (radio) head (not shown) or other display device (not shown). More than one display device can be used. Examples of display devices include, but are not limited to, a monitor, an LCD (Liquid Crystal Display), a projector, and the like.

The apparatus 101 can receive power from power supply 116. The power supply can have many unique features necessary for correct operation within the automotive environment. One mode is to supply a small amount of power (typically less than 100 microamps) to at least one master controller that can control all the other power buses inside of the VTU 101. In an exemplary system, a low power low dropout linear regulator supplies this power to PCS/Cellular modem 102. This provides the static power to maintain internal functions so that it can await external user push-button inputs or await CAN activity via vehicle interface 111. Upon receipt of an external stimulus via either a manual push button or CAN activity, the processor contained within the PCS/Cellular modem 102 can control the power supply 116 to activate other functions within the VTU 101, such as GPS 104/GYRO 105, Processor 106/Memory 107 and 108, SDARS receiver 103, audio/video entertainment system 109, audio codec mux 110, and any other peripheral within the VTU 101 that does not require standby power.

In an exemplary system, there can be a plurality of power supply states. One state can be a state of full power and operation, selected when the vehicle is operating. Another state can be a full power relying on battery backup. It can be desirable to turn off the GPS and any other non-communication related subsystem while operating on the back-up batteries. Another state can be when the vehicle has been shut off recently, perhaps within the last 30 days, and the system maintains communications with a two-way wireless network for various auxiliary services like remote door unlocking and location determination messages. After the recent shut down period, it is desirable to conserve the vehicle battery by turning off almost all power except the absolute minimum in order to maintain system time of day clocks and other functions, waiting to be awakened on CAN activity. Additional power states are contemplated, such as a low power wakeup to check for network messages, but these are nonessential features to the operation of the VTU.

Normal operation can comprise, for example, the PCS/Cellular modem 102 waiting for an emergency push button, key-press, or CAN activity. Once either is detected, the PCS/Cellular modem 102 can awaken and enable the power supply 116 as required. Shutdown can be similar wherein a first level shutdown turns off everything except the PCS/Cellular modem 102, for example. The PCS/Cellular modem 102 can maintain wireless network contact during this state of operation. The VTU 101 can operate normally in the state when the vehicle is turned off. If the vehicle is off for an extended period of time, perhaps over a vacation etc., the PCS/Cellular modem 102 can be dropped to a very low power state where it no longer maintains contact with the wireless network.

Additionally, in FIG. 1, subsystems can include a BlueTooth transceiver 115 that can be provided to interface with devices such as phones, headsets, music players, and telematics user interfaces. The apparatus can comprise one or more user inputs, such as emergency button 117 and non-emergency button 118. Emergency button 117 can be coupled to the processor 106. The emergency button 117 can be located in a vehicle cockpit and activated an occupant of the vehicle. Activation of the emergency button 117 can cause processor 106 to initiate a voice and data connection from the vehicle to a central monitoring station, also referred to as a remote call center. Data such as GPS location and occupant personal information can be transmitted to the call center. The voice connection permits two way voice communication between a vehicle occupant and a call center operator. The call center operator can have local emergency responders dispatched to the vehicle based on the data received. In another embodiment, the connections are made from the vehicle to an emergency responder center.

One or more non-emergency buttons 118 can be coupled to the processor 106. One or more non-emergency buttons 118 can be located in a vehicle cockpit and activated by an occupant of the vehicle. Activation of the one or more non-emergency buttons 118 can cause processor 106 to initiate a voice and data connection from the vehicle to a remote call center. Data such as GPS location and occupant personal information can be transmitted to the call center. The voice connection permits two way voice communications between a vehicle occupant and a call center operator. The call center operator can provide location based services to the vehicle occupant based on the data received and the vehicle occupant's desires. For example, a button can provide a vehicle occupant with a link to roadside assistance services such as towing, spare tire changing, refueling, and the like. In another embodiment, a button can provide a vehicle occupant with concierge-type services, such as local restaurants, their locations, and contact information; local service providers their locations, and contact information; travel related information such as flight and train schedules; and the like.

For any voice communication made through the VTU 101, text-to-speech algorithms can be used so as to convey predetermined messages in addition to or in place of a vehicle occupant speaking. This allows for communication when the vehicle occupant is unable or unwilling to communicate vocally.

In an aspect, apparatus 101 can be coupled to a telematics user interface located remote from the apparatus. For example, the telematics user interface can be located in the cockpit of a vehicle in view of vehicle occupants while the apparatus 101 is located under the dashboard, behind a kick panel, in the engine compartment, in the trunk, or generally out of sight of vehicle occupants.

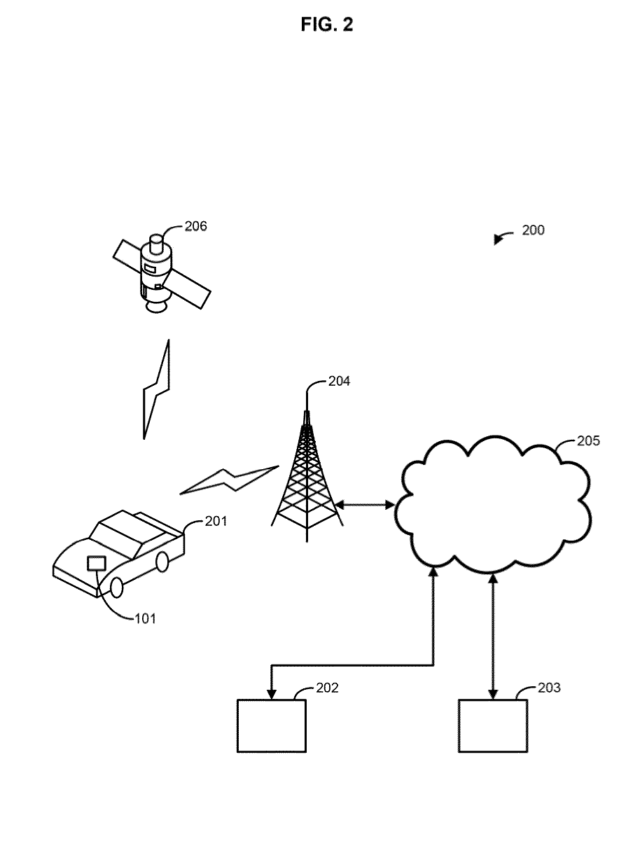

FIG. 2 is a block diagram illustrating an exemplary vehicle communication system 200 showing network connectivity between various components. The vehicle communication system 200 can comprise a VTU 101 located in a motor vehicle 201. The vehicle communication system 200 can comprise a central station 202. The central station 202 can serves as a market specific data gatekeeper. That is, users 203 can pull information from specific, multiple or all markets at any given time for immediate analysis. The distributed computing model has no single point of complete system failure, thus minimizing vehicle communication system 200 downtime. In an embodiment, central station 202 can communicate through an existing communications network (e.g. wireless towers 204 and communications network 205). Vehicle communication system 200 can comprise at least one satellite 206 from which a satellite radio provider can transmits a signal. These signals can be received by a satellite radio in the vehicle 201. In an aspect, the system can comprise one or more GPS satellites for determining vehicle 201 position.

The vehicle communication system 200 can comprise a plurality of users 203 (consumers, content providers, retail establishments, service establishments, and the like) which can access vehicle communication system 200 using a personal computer (PC) or other such computing device. For example, content providers can comprise digital music providers, digital video providers, ringtone providers, and the like. In another example, retail establishments can comprise consumer good stores such as electronics stores, clothing stores, and the like. In another example, service establishments can comprise restaurants, vehicle service stations, and the like. For simplicity, FIG. 2 shows only one user 203. The users 203 can connect to the vehicle communication system 200 via the communications network 205. In an embodiment, communications network 205 can comprise the Internet.

The vehicle communication system 200 can comprise a central station 202 which can comprise one or more central station servers. In some aspects, one or more central station servers can serve as the “back-bone” (i.e., system processing) of the present vehicle communication system 200. One skilled in the art will appreciate that vehicle communication system 200 can utilize servers (and databases) physically located on one or more computers and at one or more locations. Central station server can comprise software code logic that is responsible for handling tasks such as data interpretations, statistics processing, data preparation and compression for output to VTU 101, and report generation for output to users 203. In an embodiment of the present vehicle communication system 200, central station servers can have access to a repository database which can be a central store for all information and vehicle data within the vehicle communication system 200 (e.g., executable code, subscriber information such as login names, passwords, etc., point of interest locations, purchase information, advertisements, content, and demographics related data). Central station servers can also provide a “front-end” for the vehicle communication system 200. That is, a central station server can comprise a Web server for providing a Web site which sends out Web pages in response to requests from remote browsers (i.e., users 203). More specifically, a central station server can provide a graphical user interface (GUI) “front-end” to users 203 of the vehicle communication system 200 in the form of Web pages. These Web pages, when sent to the user PC (or the like), can result in GUI screens being displayed. Users 203 can use the front end to purchase content, setup alerts, setup triggers, send messages, provide content, provide purchase information, and the like.

As described above, VTU 101 can communicate with one or more computers, either through direct wireless communication and/or through a network such as the Internet. Such communication can facilitate data transfer, voice communication, and the like. One skilled in the art will appreciate that what follows is a functional description of an exemplary operating environment and that functions can be performed by software, by hardware, or by any combination of software and hardware.

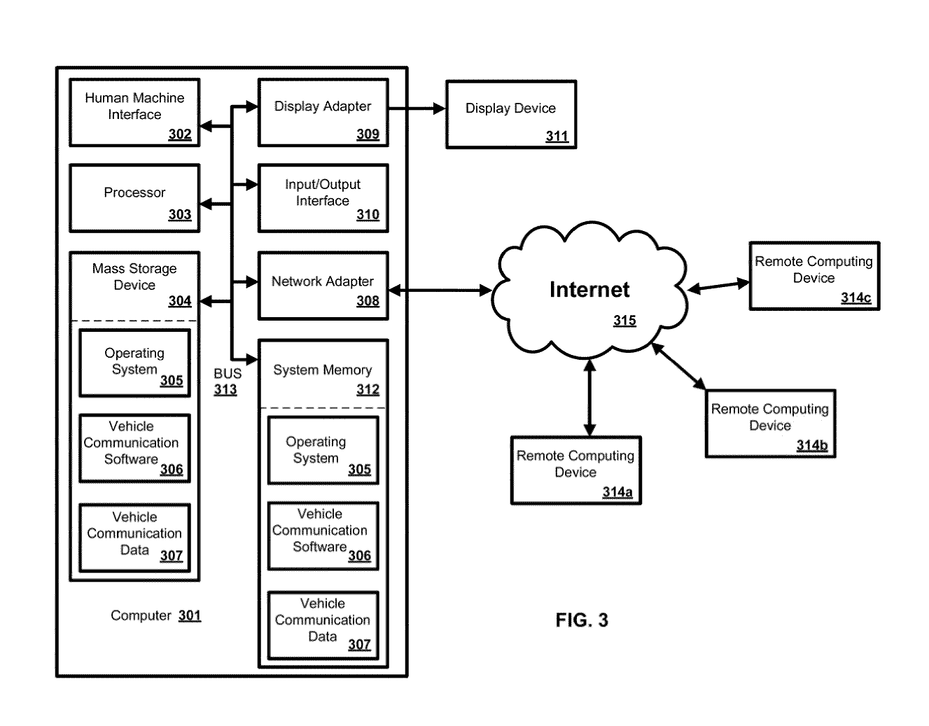

FIG. 3 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

In another aspect, the methods and systems can be described in the general context of computer instructions, such as program modules, being executed by a computer. Generally, program modules comprise routines, programs, objects, components, data structures, etc. that perform particular tasks or implement particular abstract data types. The methods and systems can also be practiced in distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 301. The components of the computer 301 can comprise, but are not limited to, one or more processors or processing units 303, a system memory 312, and a system bus 313 that couples various system components including the processor 303 to the system memory 312.

The system bus 313 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, PCI-Express bus, Universal Serial Bus (USB), and the like. The bus 313, and all buses specified in this description can also be implemented over a wired or wireless network connection and each of the subsystems, including the processor 303, a mass storage device 304, an operating system 305, telematics software 306, vehicle communication data 307, a network adapter (or communications interface) 308, system memory 312, an Input/Output Interface 310, a display adapter 309, a display device 311, and a human machine interface 302, can be contained within one or more remote computing devices 314a,b,c at physically separate locations, connected through buses of this form, in effect implementing a fully distributed system. In one aspect, a remote computing device can be a VTU 101.

The computer 301 typically comprises a variety of computer readable media. Exemplary readable media can be any available media that is accessible by the computer 301 and comprises, for example and not meant to be limiting, both volatile and non-volatile media, removable and non-removable media. The system memory 312 comprises computer readable media in the form of volatile memory, such as random access memory (RAM), and/or non-volatile memory, such as read only memory (ROM). The system memory 312 typically contains data such as vehicle communication data 307 and/or program modules such as operating system 305 and vehicle communication data processing software 306 that are immediately accessible to and/or are presently operated on by the processing unit 303. Vehicle communication data 307 can comprise any data generated by, generated for, received from, or sent to the VTU.

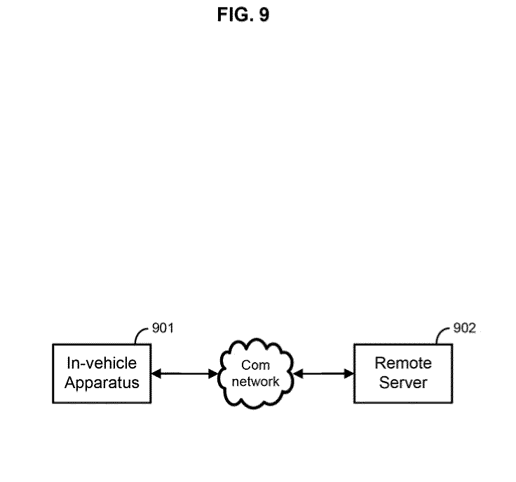

In another aspect, the computer 301 can also comprise other removable/non-removable, volatile/non-volatile computer storage media. By way of example, FIG. 9 illustrates a mass storage device 304 which can provide non-volatile storage of computer code, computer readable instructions, data structures, program modules, and other data for the computer 301. For example and not meant to be limiting, a mass storage device 304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 304, including by way of example, an operating system 305 and vehicle communication data processing software 306. Each of the operating system 305 and vehicle communication data processing software 306 (or some combination thereof) can comprise elements of the programming and the vehicle communication data processing software 306. Vehicle communication data 307 can also be stored on the mass storage device 304. Vehicle communication data 307 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 301 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 303 via a human machine interface 302 that is coupled to the system bus 313, but can be connected by other interface and bus structures, such as a parallel port, game port, an IEEE 1394 Port (also known as a Firewire port), a serial port, or a universal serial bus (USB).

In yet another aspect, a display device 311 can also be connected to the system bus 313 via an interface, such as a display adapter 309. It is contemplated that the computer 301 can have more than one display adapter 309 and the computer 301 can have more than one display device 311. For example, a display device can be a monitor, an LCD (Liquid Crystal Display), or a projector. In addition to the display device 311, other output peripheral devices can comprise components such as speakers (not shown) and a printer (not shown) which can be connected to the computer 301 via Input/Output Interface 310.

The computer 301 can operate in a networked environment using logical connections to one or more remote computing devices 314a,b,c. By way of example, a remote computing device can be a personal computer, portable computer, a server, a router, a network computer, a VTU 101, a PDA, a cellular phone, a “smart” phone, a wireless communications enabled key fob, a peer device or other common network node, and so on. Logical connections between the computer 301 and a remote computing device 314a,b,c can be made via a local area network (LAN) and a general wide area network (WAN). Such network connections can be through a network adapter 308. A network adapter 308 can be implemented in both wired and wireless environments. Such networking environments are conventional and commonplace in offices, enterprise-wide computer networks, intranets, and the Internet 315. In one aspect, the remote computing device 314a,b,c can be one or more VTU 101's.

For purposes of illustration, application programs and other executable program components such as the operating system 305 are illustrated herein as discrete blocks, although it is recognized that such programs and components reside at various times in different storage components of the computing device 301, and are executed by the data processor(s) of the computer. An implementation of vehicle communication data processing software 306 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

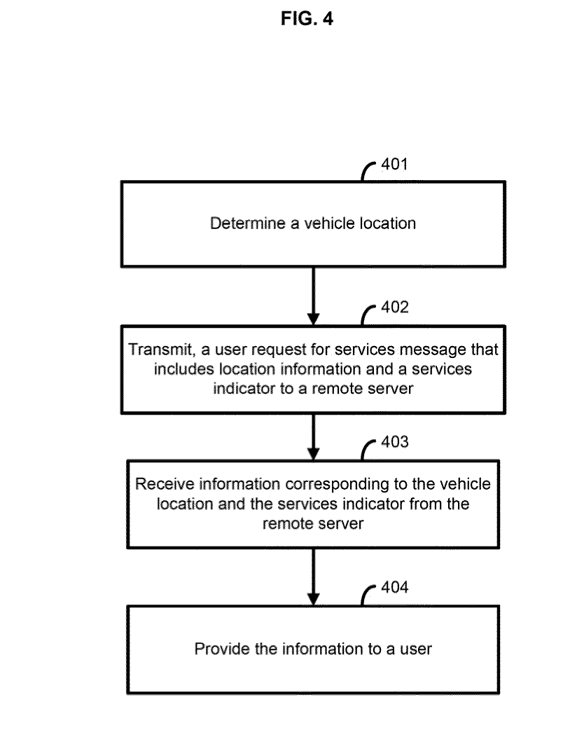

In an aspect, illustrated in FIG. 4, provided are methods for vehicle communication, comprising determining a vehicle location at 401, transmitting the vehicle location to a remote server at 402, receiving information corresponding to the vehicle location from the remote server at 403, and providing the information to a first user at 404.

The methods can further comprise a processor of the TCU performing steps 401-404 upon the receiving of request command generated by an affirmative act by a user at step 401, such as pushing a button on a device in the vehicle, selecting an graphical user interface option on a computer display, speaking a command into a device that can process a voice command into a computer command, or automatically upon occurrence of a vehicular trigger event. The vehicular trigger event can be, for example, one or more of, low fuel, check engine indication, tire pressure indication, oil pressure indication, water temperature indication, mileage thresholds, battery status, and the like. In addition, a user remote from the vehicle can cause a processor at a telematics control unit of a vehicle to perform steps 401-404 upon generation of a request command, such as by making a selection by clicking an option using an internet web browser at a device remote from the vehicle.

The information received at step 403 can pertain to at least one good or service provider related to the vehicular trigger event, or the selection made affirmatively by either the vehicle's user or a remote user. Typically, the information received at step 403 will also relate to the vehicle's location at the time the trigger occurred, or when the affirmative action, or selection, was performed. The good or service provider can comprise one or more of, a gas station, a service station, a tire store, an auto parts store, and the like. The information can comprise an advertisement. At least one good or service provider can have paid to have information pertaining to the at least one good or service provider provided to the user. The methods can further comprise maintaining a record of advertisement impressions.

For example, a telematics server may generate, aggregate from various database sources, or retrieve from its database records, the coordinates, and street address, of fuel stations within a 1-mile radius when it receives a message that a vehicle's TCU transmitted at step 402. The information sent by the server, which the TCU receives at step 403 may include advertisements for one, or more, of the fuel stations. The advertisements may advertise the price of fuel, any type of food items the station may sell, or other items and services the station my offer for sale. The telematics server may transmit the advertisement as a video, or audio file, which a receiving vehicle's on-board media player may play, or provide, to the user in the vehicle or at a remote location.

The media player may obtain statistics that indicate whether the user acknowledged the advertisement. For example, the media player may determine that the user used the media player's volume control to reduce the volume of the advertisement while it played. Or, that the user selected a control that stops play of the advertisement media file. The media player, which would typically be coupled to a vehicle's telematics unit, or TCU, could then transmit back to the temelatics server, or server of another interested party, such as the advertiser's server, metrics that indicate whether, and how far into a given advertisement, the user reduced volume during playing of the advertisement. Advertisers may use these data to evaluate the effectiveness of their advertisements.

As discussed above, the methods can further comprise a processor, such as a processor in a telematics unit, performing steps 401-404 in response to a user-defined request initiated by a user either in a vehicle to which the request pertains, or remote from the vehicle. The user-defined request can comprise one, or more of, a request for a particular good or service and a request for a particular class of good or service. The particular good or service can be, for example, a house for sale, a hotel, a restaurant reservation, a consumer good, fuel, energy, and the like. The information pertains to at least one good or service provider related to the user defined request. The good or service provider can comprise one or more of, a fuel station, an energy station, a service station, a tire store, an auto parts store, a restaurant, a consumer goods store, and the like.

The methods can further comprise transmitting the information to a second user at the request of the first user (e.g., a spouse remote from the vehicle operating a computer browser transmitting the information to the other spouse in the vehicle). The methods can further comprise transmitting an order for a good or service from the first user to a good or service provider. The order can be predetermined by the first user. The methods can further comprise receiving an order from the first user in response to providing the information to the first user. The order can comprise an estimated time of arrival at the good or service provider. The information can correspond to a location of a good or service provider. The methods can further comprise receiving a selection of the good or service provider and providing navigation direction to the good or service provider.

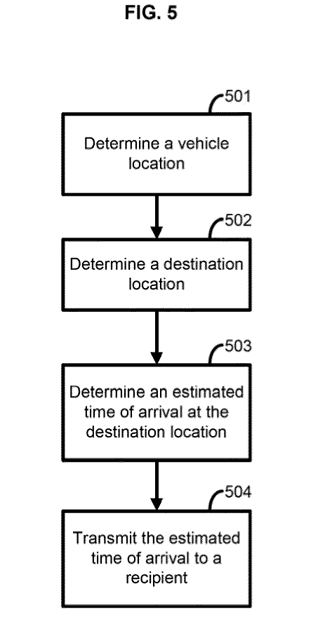

In another aspect, illustrated in FIG. 5, provided are methods for vehicle communication, comprising determining a vehicle location at 501, determining a destination location at 502, determining an estimated time of arrival at the destination location at 503, and transmitting the estimated time of arrival to a recipient at 504.

The estimated time of arrival can be an arrival time. The estimated time of arrival can be the amount of time until arrival. Transmitting the estimated time of arrival to a recipient can comprise at least one of, sending a short message service message, sending an email, sending an automated voice message, and the like.

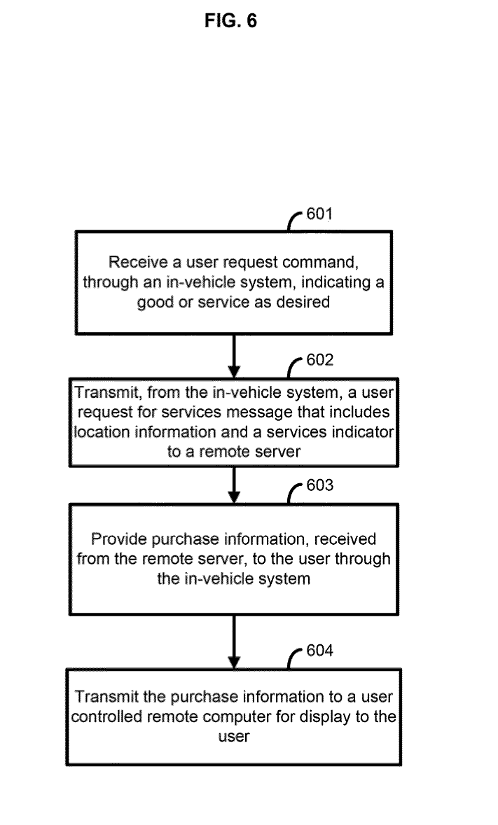

In a further aspect, FIG. 6 illustrates methods for mobile commerce, comprising receiving a user request command at an in-vehicle system, the request for services command indicating a desired good or service at 601, transmitting, from the in-vehicle system, the user request command to a remote server at 602, providing purchase information, received from the remote server, to the user through the in-vehicle system at 603, and also transmitting the purchase information to a user controlled remote computer for display to the user at 604.

For example, the in-vehicle system may be coupled to media player display, such as a ‘head-unit’. ‘Head-unit’ is an automobile industry term that broadly refers to a device, or system, that may comprise an AM/FM/Satellite radio, a CD player, a DVD player, an mp3 player, a navigation system, etc. At step 603 the TCU at the vehicle would receive and cause the head-unit to display the information received from a telematics, or remote, server. Or, the TCU may not be coupled to, or integrated with, a head unit, but may transmit the information it received from the server to a separate device, such as a navigation system screen, a cellular telephone screen, or another device that is not directly coupled to the TCU. The TCU may transmit the information to the other device wirelessly, via Wi-Fi, Bluetooth, or other similar wireless transmission protocol.

The good or service can be a song, for example. Thus, a user request may include a request to purchase the song based on the information provided in response to hearing a segment of the song. The request may also include instructions to download the purchased song to a device in the vehicle through the telematics TCU, or to another device, such as a smartphone or other device that can receive data wirelessly. The methods can further comprise receiving a user request to purchase the song for use as an in-vehicle ringtone based on the information provided, downloading the purchased song to the in-vehicle system, and installing the ringtone in an in-vehicle phone system.

The good or service can be a product advertised on an in-vehicle radio. The purchase information can comprise information regarding related goods or services. The purchase information can be an advertisement. The methods can further comprise maintaining a record of advertisement impressions.

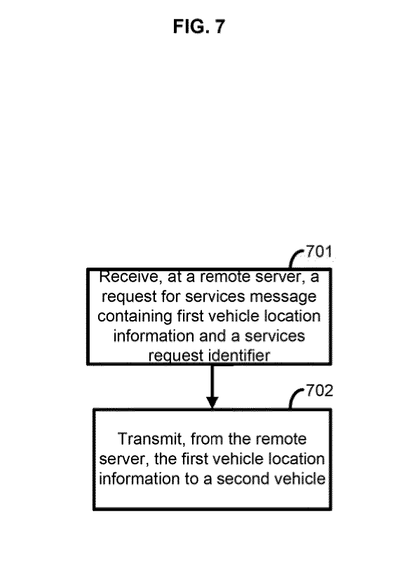

In another aspect, illustrated in FIG. 7, provided are methods for vehicle communication, comprising receiving, at a remote server, a first vehicle location from a first vehicle at 701 and transmitting, from the remote server, the first vehicle location to a second vehicle at 702.

The methods can further comprise receiving, at the remote server, the second vehicle location from the second vehicle and transmitting, from the remote server, the second vehicle location to the first vehicle. Receiving, at a remote server, a first vehicle location from a first vehicle can be performed at the request of an occupant of the first vehicle. The first vehicle location can be a destination stored in an onboard navigation system. The methods can further comprise entering the first vehicle location into an onboard navigation system of the second vehicle.

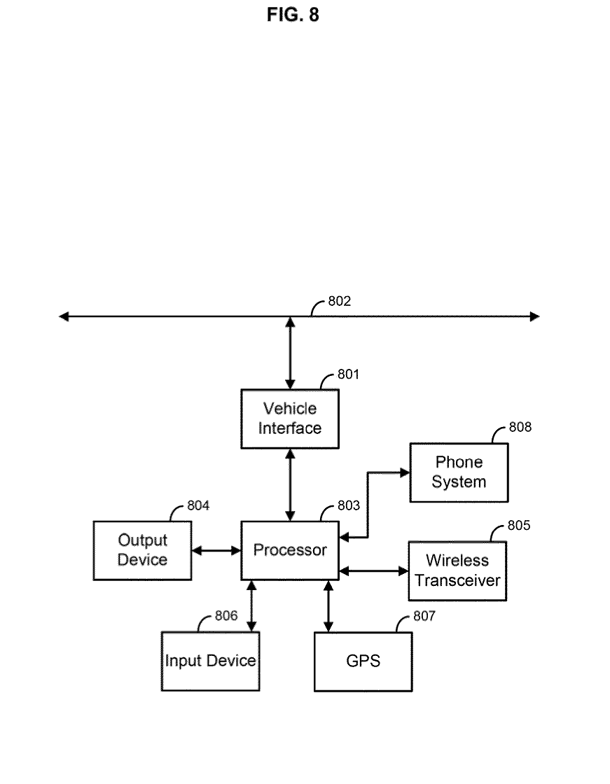

In another aspect, provided are apparatuses capable of performing the methods disclosed in whole or in part. An exemplary apparatus is shown in FIG. 8. In various embodiments of the apparatus some components are optional, depending on the method implemented, as is known to one of ordinary skill in the art. An exemplary apparatus can comprise a vehicle interface 801, coupled to a vehicle bus 802. A processor can be coupled to the vehicle interface 801. The apparatus can further comprise an output device 804 and/or an input device 806, both coupled to the processor 803. The apparatus can further comprise a wireless transceiver 805 coupled to the processor 803. The apparatus can further comprise a location determination unit, such as GPS 807 coupled to the processor 803. The apparatus can further comprise a phone system 808 coupled to the processor 803.

Accordingly, in one aspect an apparatus for vehicle communication comprises a location determination component, such as global positioning satellite (“GPS”) circuitry configured to determine a vehicle location, a wireless transceiver, such as a cellular telephony circuit, or a bluetooth circuit, configured to send and receive information, an output device, such as a graphical display screen, an audio speaker, or an alphanumeric display, for example, configured to provide information to a user, and a processor, coupled to the location determination unit, the wireless transceiver, and the output device, wherein the processor is configured for a) processing information from the location determination unit to determine information related to a location of the vehicle such as latitude and longitude coordinates, b) controlling the sending of the vehicle location information to a remote server, c) processing information received from the remote server that relates to the vehicle's location, and d) controlling the sending of the information to a first user.

The apparatus can further comprise a vehicle interface, coupled to the processor and a vehicle bus, configured for determining occurrence of a vehicular trigger event. For example, when the vehicle's on-board diagnostics system generates a code on a vehicle bus, such as a CAN bus, that the vehicle's fuel level, or stored energy level, drops to a predetermined threshold, upon processing the low fuel code received from the vehicle's diagnostic system, the processor can generate a request for nearby fuel, or energy, stations. In generating the request, the processor can include information related to the vehicle's current location, and include it in the request message along with a services type, in this case, fuel services. The processor can then cause the wireless transmitter to transmit the request message to a server, such as a telematics server. When the telematics sever receives the request, it can look up in various databases, either locally with respect to the server, or remotely, and determine, based on the vehicle location information and the services indicator type, multiple fuel stations within a predetermined distance (either radius, or distance along passable ways) of the vehicle's current location.

The processor of the apparatus can be further configured for performing steps a-d automatically upon occurrence of a vehicular trigger event. The vehicular trigger event can be one or more of, low fuel, check engine indication, tire pressure, indication, oil pressure indication, water temperature indication, mileage thresholds, battery status, and the like. The information can pertain to at least one good or service provider related to the vehicular trigger event. The good or service provider can comprise one or more of, a gas station, a service station, a tire store, an auto parts store, and the like.

The apparatus can further comprise an input device, coupled to the processor, configured for receiving a user defined request for services command. The input device may include a keypad, a keyboard, a touch sensitive screen, a pointer device, such as a trackball or a mouse, a voice recognition application coupled to a microphone, a pushbutton configured to a generate a request that has been associated with the button, and other similar types of user input devices. The processor of the apparatus can be further configured for performing steps a-d in response to a user defined request for services command. The user defined request can comprise one, or more of, a request for a particular good or service and a request for a particular class of good or service. The particular good or service can be a house, a restaurant reservation, a consumer good, roadside assistance services, and the like.

The information can pertain to at least one good or service provider related to the user defined request. The good or service provider can comprise one or more of, a gas station, a service station, a tire store, an auto parts store, a restaurant, a consumer goods store, and the like. The information can comprise an advertisement. At least one good or service provider can have paid to have information pertaining to the at least one good or service provider provided to the user. The processor of the apparatus can be further configured for maintaining a record of advertisement impressions.

The processor of the apparatus can be further configured to send the information to a second user based upon a request instruction initiated by the first user. The processor of the apparatus can be further configured to send an order for a good or service from the first user to a good or service provider. The order can be predetermined by the first user. The processor of the apparatus can be further configured to receive an order from the first user in response to providing the information to the first user. The order can comprise an estimated time of arrival at the good or service provider. The information can correspond to, or relate to, a location of a good or service provider. The processor of the apparatus can be further configured for receiving a selection of the good or service provider and providing navigation direction to the good or service provider.

In another aspect, provided is an apparatus for vehicle communication, comprising a location determination unit, configured to determine location information that corresponds to a vehicle's location, a wireless transceiver, configured to send and receive information and data, an input device, coupled to the processor, configured for receiving a destination location, and a processor, coupled to the location determination unit, the wireless transceiver, and the input device, wherein the processor is configured for determining a vehicle location, determining a destination location, determining an estimated time of arrival at the destination location, sending the estimated time of arrival to a recipient.

The estimated time of arrival can be an arrival time. The estimated time of arrival can be the amount of time until arrival. Transmitting the estimated time of arrival to a recipient can comprise at least one of, sending a short message service message, sending an email, sending an automated voice message, and the like.

In a further aspect, provided is an apparatus for vehicle communication, comprising a location determination unit, configured to determine a vehicle location, a wireless transceiver, configured to send and receive information, an input device, coupled to the processor, configured for receiving a user request, an output device, configured to provide information to a user, and a processor, coupled to the location determination unit, the wireless transceiver, the input device, and the output device, wherein the processor is configured for receiving a user request indicating a good or service as desired, transmitting the user request to a remote server, receiving purchase information from the remote server, and providing the purchase information to the user.

The good or service can be a song. The processor of the apparatus can be further configured to receive a user request to purchase the song based on the information provided and downloading the purchased song.

The apparatus can further comprise a phone system, coupled to the processor, wherein the processor can be further configured for receiving a command from the user to purchase the song for use as a ringtone based on the information provided, downloading the purchased song, and installing the ringtone in the phone system.

The good or service can be a product advertised on an in-vehicle radio. The purchase information can comprise information regarding related goods or services. The purchase information can be an advertisement. The processor can be further configured to maintain a record of advertisement impressions.

In an aspect, an apparatus for vehicle communication comprises a communications unit, configured for sending and receiving information, a processor, coupled to the communications unit, configured for receiving a first vehicle location from a first vehicle, determining a second vehicle to be a recipient for the first vehicle location, and transmitting the first vehicle location to the second vehicle. The processor can be further configured to receive the second vehicle location from the second vehicle and to send the second vehicle location to the first vehicle. Receiving a first vehicle location from a first vehicle can be performed at the request of an occupant of the first vehicle. The first vehicle location can be a destination stored in an onboard navigation system.

In another aspect, provided are systems capable of performing any of the methods disclosed in whole or in part. An exemplary system is shown in FIG. 9. In various embodiments of the systems some components are optional, depending on the method implemented, as is known to one of ordinary skill in the art. The system can comprise an in-vehicle apparatus, as disclosed herein, communicating with a remote server 902 over a communication network, such that may include a wireless communication network and the internet.

In an aspect, systems for vehicle communication comprise an in-vehicle device, configured for a) determining a vehicle location, b) transmitting the vehicle location to a remote server, c) receiving information corresponding to the vehicle location from the remote server, and d) providing the information to a first user, and a remote server, configured for providing information corresponding to the vehicle location to the in-vehicle device.

The in-vehicle device can comprise a vehicle interface configured for determining occurrence of a vehicular trigger event. The in-vehicle device can be further configured for performing steps a-d automatically upon occurrence of a vehicular trigger event. The vehicular trigger event can be one or more of low fuel, check engine indication, tire pressure indication, oil pressure indication, water temperature indication, mileage thresholds, battery status, and the like.

The information can pertain to at least one good or service provider related to the vehicular trigger event. The good or service provider can comprise one or more of, a gas station, a service station, a tire store, an auto parts store, and the like.

The in-vehicle device can comprise an input device configured for receiving a user defined request. The in-vehicle device can be configured for performing steps a-d in response to a user defined request. The user defined request can comprise one or more of, a request for a particular good or service and a request for a particular class of good or service. The particular good or service can be a house, a restaurant reservation, a consumer good, and the like. The information can pertain one good or service provider related to the user defined request.

The good or service provider can comprise one or more of, a gas station, a service station, a tire store, an auto parts store, a restaurant, a consumer goods store, and the like. The information can comprise an advertisement. At least one good or service provider can have paid to have information pertaining to the at least one good or service provider provided to the user. The methods can further comprise maintaining a record of advertisement impressions.

The system can be further configured for transmitting the information to a second user at the request of the first user. The system can be further configured for transmitting an order for a good or service from the first user to a good or service provider. The order can be predetermined by the first user. The system can be further configured for receiving an order from the first user in response to providing the information to the first user. The order can comprise an estimated time of arrival at the good or service provider. The information can correspond to a location of a good or service provider. The system can be further configured for receiving a selection of the good or service provider and providing navigation direction to the good or service provider.

In another aspect a system for mobile commerce comprise an in-vehicle device, configured for receiving a user request indicating a good or service as desired, transmitting the user request to a remote server, providing purchase information, received from the remote server, to the user and a remote server, configured for receiving the user request, determining purchase information related to the user request, transmitting the purchase information to the in-vehicle device, and transmitting the purchase information to a user controlled remote computer for display to the user.

The good or service can be a song. The system can be further configured for receiving a user request to purchase the song based on the information provided and downloading the purchased song to the in-vehicle system. The system can be further configured for receiving a command from the user to purchase the song for use as an in-vehicle ringtone based on the information provided, downloading the purchased song to the in-vehicle system, and installing the ringtone in an in-vehicle phone system.

The system can be further configured for receiving a command from the user to purchase the song for use as an in-vehicle ringtone based on the information provided, downloading the purchased song to the in-vehicle system, and installing the ringtone in an in-vehicle phone system.

The good or service can be a product advertised on an in-vehicle radio. The purchase information can comprise information regarding related goods or services. The purchase information can be an advertisement. The system can be further configured for maintaining a record of advertisement impressions.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for providing services, comprising:
receiving a request for service command that includes an indicator of the type of services requested;
determining current location information corresponding to the current location of a vehicle;
processing the request for services and the current location information into a request for services message;
transmitting the request for services message to a remote server;
receiving a response message that contains information responsive to the request for services message, the response message including information corresponding to the services type indication and the current location information; and
performing a task based on the information received in the response message at the vehicle.

2. The method of claim 1 wherein the service requested is the providing of information related to fuel stations within a predetermined distance of the current location of the vehicle.

3. The method of claim 2 wherein the predetermined distance is a radius distance from the current location of the vehicle.

4. The method of claim 1 wherein the information contained in the response message includes advertisement media files that contain promotional information associated with providers of services requested in the request message.

5. The method of claim 4 further comprising playing the advertisement media files, monitoring metrics related to the playing of the media files, and transmitting information corresponding to the monitored metrics to the remote server.

6. The method of claim 5 wherein the monitored metrics include volume level of an audio system as it plays one, or more, of the media files.

7. The method of claim 5 wherein the monitored metrics include whether the message was stopped before playing of it had completed.

8. The method of claim 7 wherein the monitored metrics includes how far into playing of a media file a user terminated the playing.

9. A method for providing services, comprising:
receiving at a server a request for services message that includes an indicator of a type of services requested and location information corresponding to a device that transmitted the request for services message; and
transmitting a response message that contains information responsive to the request for services message, the response message including information corresponding to the services type indication and the current location information.

10. The method of claim 9 further comprising:
receiving a predetermined range distance relative to location information that may be received in a request for services message;
searching a table, indexed on a services indicator field, for entries with a value in their respective services indicator field that match the services indicator received in the request for services message;
filtering out entries from the results of the search of the table that have corresponding location information indicating that a corresponding service provider lies outside the range distance relative the location information received in the request for services message, and
generating the response message with the entries from the search of the table that remain after filtering out the entries having location information indicating that the corresponding service provider lies outside the predetermined range distance relative to the location information received in the request for services message.

11. The method of claim 9 wherein the information contained in the response message includes advertisement media files that contain promotional information associated with providers of services requested in the request message.

12. The method of claim 11 further comprising receiving information corresponding to the monitored metrics.

13. The method of claim 12 further comprising transmitting the received information corresponding to the monitored metrics to a services provider associated with the promotional information.

14. A telematics control unit, comprising a processor configured to:
receive a request for service command that includes an indicator of the type of services requested;
determine current location information corresponding to the current location of a vehicle;
process the request for services and the current location information into a request for services message;
transmit the request for services message to a remote server;
receive a response message that contains information responsive to the request for services message, the response message including information corresponding to the services type indication and the current location information; and
perform a task based on the information received in the response message at the vehicle.
